(19) United States
(12) Patent Application Publication
(10) Pub. No.: US 2024/0063857 A1
(43) Pub. Date: Feb. 22, 2024

(54) Uplink Multi-Panel Transmission

(71) Applicant: Apple Inc., Cupertino, CA (US)

(72) Inventors: Yushu ZHANG, Beijing (CN); Chunhai YAO, Beijing (CN); Chunxuan YE, San Diego, CA (US); Dawei ZHANG, Saratoga, CA (US); Haitong SUN, Cupertino, CA (US); Hong HE, San Jose, CA (US); Huaning NIU, San Jose, CA (US); Jie CUI, San Jose, CA (US); Oghenekome OTERI, San Diego, CA (US); Qiming LI, Beijing (CN); Seyed Ali Akbar FAKOORIAN, San Diego, CA (US); Sigen YE, San Diego, CA (US); Wei ZENG, Saratoga, CA (US); Weidong YANG, San Diego, CA (US)

(21) Appl. No.: 17/754,548

(22) PCT Filed: Apr. 6, 2021
(86) PCT No.: PCT/CN2021/085682

§ 371 Date: Apr. 5, 2022

(51) Int. Cl. H04B 7/0456; H04L 5/00; H04W 52/14

(52) U.S. Cl. CPC H04B 7/0465; H04L 5/0023; H04L 5/0048; H04W 52/146

(57) ABSTRACT

Embodiments of the present disclosure relate to uplink multi-panel transmission. According to embodiments of the present disclosure, a user equipment (UE) comprises a transceiver configured to communicate with a network; and a processor communicatively coupled to the transceiver and configured to perform operations. The operations comprise determining a density of Phase Tracking-Reference Signal (PT-RS) to be transmitted from each panel and transmitting the PT-RS from the respective panel. The operations further comprise performing power control for the uplink multi-panel transmission.

### TECHNICAL FIELD

Embodiments of the present disclosure generally relate to the field of telecommunications, and in particular, to uplink multi-panel transmission.

### BACKGROUND

For the fifth generation (5G) system operating above 6 GHz, a user equipment (UE) may comprise multiple antenna panels (also referred to as “panels”) and maintain a plurality of spatial domain transmission filters. Then, the UE is able to transmit uplink signals from the multiple antenna panels.

### SUMMARY

In general, example embodiments of the present disclosure provide a solution for uplink multi-panel transmission.

In a first aspect, there is provided a user equipment. The user equipment comprises a transceiver and a processor. The transceiver is configured to communicate with a network. The processor is communicatively coupled to the transceiver and configured to perform operations comprising: determining a density of a Phase Tracking-Reference Signal (PT-RS) to be transmitted from a first panel of a plurality of panels of the user equipment based on a bandwidth scheduled for at least one of the plurality of panels; mapping the PT-RS to physical resources based on the density; and transmitting the PT-RS via the transceiver from the first panel to the network by using the mapped physical resources.

In a second aspect, there is provided a user equipment. The user equipment comprises a transceiver and a processor. The transceiver is configured to communicate with a network. The processor is communicatively coupled to the transceiver and configured to perform operations comprising: determining whether a total transmission power of a plurality of uplink transmissions to be performed from a first panel of the user equipment exceeds a maximum transmission power of the first panel, the plurality of uplink transmissions overlapped in time; in accordance with a determination that the total transmission power exceeds the maximum transmission power, reducing a transmission power of a first uplink transmission of the plurality of uplink transmissions to reduce the total transmission power, the first uplink transmission having a lower priority than a second uplink transmission of the plurality of uplink transmissions; and causing the plurality of uplink transmissions to be performed from the first panel with the reduced total transmission power.

In a third aspect, there is provided a user equipment. The user equipment comprises a transceiver and a processor. The transceiver is configured to communicate with a network. The processor is communicatively coupled to the transceiver and configured to perform operations comprising: determining whether a total transmission power of a plurality of uplink transmissions to be performed by the user equipment comprising a plurality of panels exceeds a maximum transmission power of the user equipment , the plurality of uplink transmissions overlapped in time; in accordance with a determination that the total transmission power exceeds the maximum transmission power, reducing a transmission power of a target uplink transmission to be performed from at least one of the plurality of panels to reduce the total transmission power; and causing the plurality of uplink transmissions to be performed by the user equipment with the reduced total transmission power.

In a fourth aspect, there is provided a baseband processor of a user equipment according to any of the above first, second and third aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example communication network in which example embodiments of the present disclosure can be implemented;

FIG. 2A illustrates a schematic diagram of PT-RS transmissions from a plurality of panels in Frequency Division Multiplexing (FDM) mode according to some embodiments of the present disclosure;

FIG. 2B illustrates a schematic diagram of PT-RS transmissions from a plurality of panels in Spatial Division Multiplexing (SDM) mode according to some embodiments of the present disclosure;

FIG. 3 illustrates a flowchart of an example method for PT-RS transmission for multi-panel according to some embodiments of the present disclosure;

FIG. 4 illustrates a schematic diagram of a density of PT-RS within a symbol according to some embodiments of the present disclosure;

FIG. 5A illustrates a schematic diagram of uplink transmissions fully overlapped according to some embodiments of the present disclosure;

FIG. 5B illustrates a schematic diagram of uplink transmissions overlapped in transmission occasion level according to some embodiments of the present disclosure;

FIG. 5C illustrates a schematic diagram of uplink transmissions overlapped in other level according to some embodiments of the present disclosure;

FIG. 6 illustrates a flowchart illustrating an example method of power control for multi-panel transmission according to some embodiments of the present disclosure;

FIG. 7A illustrates an example of power reduction in the case where the uplink transmissions are overlapped in transmission occasion level according to some embodiments of the present disclosure;

FIG. 7B illustrates another example of power reduction in the case where the uplink transmissions are overlapped in transmission occasion level according to some embodiments of the present disclosure;

FIG. 8A illustrates an example of power reduction in the case where the uplink transmissions are overlapped in other levels according to some embodiments of the present disclosure;

FIG. 8B illustrates another example of power reduction in the case where the uplink transmissions are overlapped in other levels according to some embodiments of the present disclosure;

FIG. 9 illustrates a flowchart illustrating another example method of power control for multi-panel transmission according to some embodiments of the present disclosure; and

FIG. 10 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the term “multi-panel transmission” refers to transmission from multiple antenna panels. An antenna panel can be considered as one UE antenna port(s) group.

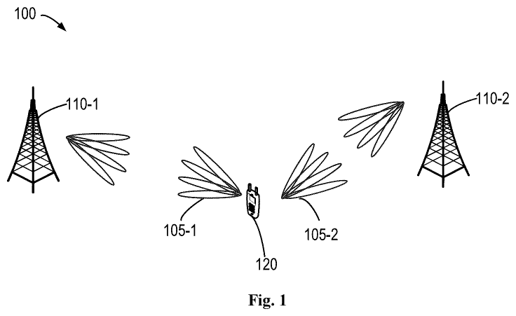

FIG. 1 shows an example communication network 100 in which embodiments of the present disclosure can be implemented. The network 100 includes two base stations (BSs) 110-1 and 110-2, which may be collectively referred to as “BSs 110” or individually referred to as a “BS 110”, and a UE 120 served by the network device 110. The UE 120 may have a plurality of panels for transmission. For example, FIG. 1 shows a panel 105-1 and a panel 105-2, which may be collectively referred to as “panels 105” or individually referred to as a “panel 105”.

It is to be understood that the numbers of BSs 110, UEs 120 and panels 105 as shown in FIG. 1 are only for the purpose of illustration without suggesting any limitations. The network 100 may include any suitable number of BSs, UEs and panels adapted for implementing embodiments of the present disclosure.

In the communication network 100, the BS 110 can communicate data and control information to the UE 120 and the UE 120 can also communication data and control information to the BS 110. A link from the BS 110 to the UE 120 is referred to as a downlink (DL) or a forward link, while a link from the UE 120 to the BS 110 is referred to as an uplink (UL) or a reverse link. For uplink multi-panel transmission, the UE 120 may transmit data and control information from different panels to a corresponding BS 110, for example, a corresponding gNodeB (gNB). The signals from the multiple panels 105 may be transmitted in FDM mode, SDM mode, or hybrid FDM/SDM mode.

In Release 15, both Discrete Fourier Transform (DFT)-spread-Orthogonal Frequency Division Multiplexing (DFT-s-OFDM) and Cyclic-Prefix Orthogonal Frequency Division Multiplexing (CP-OFDM) waveforms are supported for uplink transmissions. For both the DFT-OFDM and CP-OFDM waveforms, Phase Tracking References Signal (PTRS) is supported for phase offset compensation.

Conventionally, in the case of DFT-s-OFDM waveform, the PT-RS and data are multiplexed within symbols before DFT. The PT-RS density and resource mapping pattern are determined based on the number of allocated Resource Blocks (RBs) for the UE. In the case of CP-OFDM waveform, the PT-RS is mapped to symbols without DeModulation Reference Signal (DMRS). The PT-RS density and resource mapping pattern is determined based on a bandwidth scheduled for the UE and a Modulation and Coding Scheme (MCS) indicated by the BS for the UE.

Therefore, in the conventional solution, the PT-RS and data are multiplexed for compensating the phase offset of the UE. However, for multi-panel transmissions, different panels of the UE may have different phase noises. Thus, the PT-RS may be required to be transmitted in each panel for compensating a respective phase noise. Therefore, a solution for multiplexing PT-RS and data in each panel is needed.

Some embodiments of the present disclosure provide a solution for transmitting PT-RS in each panel to compensate a respective phase noise of the panel. In this solution, a UE comprises a transceiver configured to communicate with a network and a processer communicatively coupled to the transceiver. The UE determines a density of a PT-RS to be transmitted from a first panel of a plurality of panels of the UE based on a bandwidth scheduled for at least one of the plurality of panels. The UE maps the PT-RS to physical resources based on the density. The UE transmits the PT-RS via the transceiver from the first panel to the network by using the mapped physical resources.

According to the embodiments of the present disclosure, the UE determines a density of PT-RS to be transmitted from each panel and thus transmits the PT-RS from the corresponding panel by using physical resources mapping to the PT-RS. In this way, the UE can transmit the PT-RS from each panel so as to compensate the phase noise in the respective panel of the UE.

Generally, to compensate for the respective phase noise of each panel, determination of the PT-RS density, the resource mapping and sequence generation may be performed for each panel. Thus, for DFT-s-OFDM, the DFT operation may be performed for each panel and the size of DFT may be equal to the number of scheduled subcarriers per panel. For example, in FDM mode, SDM mode or hybrid FDM/SDM mode, the UE 120 may perform the DFT operation per panel and determine the size of DFT as equal to the number of scheduled subcarriers per panel.

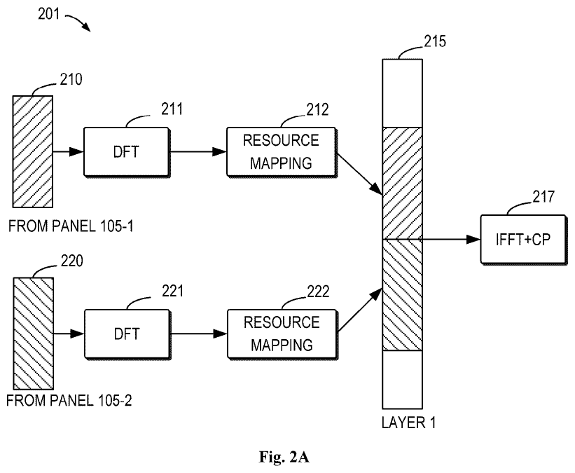

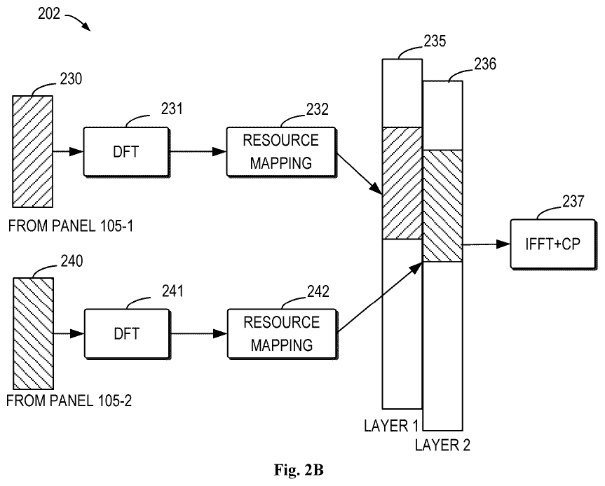

Reference is now made to FIG. 2A. FIG. 2A illustrates a schematic diagram 201 of PT-RS transmissions from a plurality of panels in FDM mode according to some embodiments of the present disclosure. As shown in FIG. 2A, the DFT 211 and resource mapping 212 are successively performed on a modulated symbol 210 from the panel 105-1. The DFT 221 and resource mapping 222 are successively performed on a modulated symbol 220 from the panel 105-2. Thus, the PT-RSs from different panels 105-1 and 105-2 are mapped to the physical resources 215 of the same layer 1. Then, Invert Fast Fourier Transformation (IFFT) and cyclic prefix (CP) 217 operations are performed.

Reference is now made to FIG. 2B. FIG. 2B illustrates a schematic diagram 202 of PT-RS transmissions from a plurality of panels in SDM mode according to some embodiments of the present disclosure. As shown in FIG. 2B, the DFT 231 and resource mapping 232 are successively performed on modulated symbols 230 from the panel 105-1. The DFT 241 and resource mapping 242 are successively performed on modulated symbols 240 from the panel 105-2. Thus, the PT-RS from the panel 105-1 is mapped to the physical resources 235 of the layer 1 and the PT-RS from the panel 105-2 is mapped to the physical resources 236 of the layer 2. Then, Invert Fast Fourier Transformation (IFFT) and cyclic prefix (CP) 237 operations are performed.

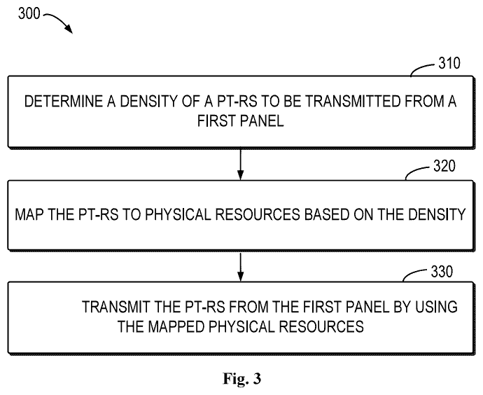

As can be seen from FIGS. 2A and 2B, according to some embodiments of the present disclosure, the PT-RS transmissions from different panels are handled separately before mapping to physical resources. Similar operations may apply to other OFDM waveforms. Principle and implementations of the present disclosure will be described in detail below with reference to FIGS. 3-6.

Reference is now made to reference to FIG. 3. FIG. 3 illustrates a flowchart of an example method 300 for PT-RS transmission for multi-panel operation according to some embodiments of the present disclosure. For the purpose of discussion, the method 300 will be described with reference to FIGS. 1-2. The method 300 may involve the UE 120 shown in FIG. 1.

At block 310, the UE 120 determines a density of a PT-RS to be transmitted from a first panel of a plurality of panels 105 of the UE 120. The UE 120 determines the density based on a bandwidth scheduled for at least one of the plurality of panels 105, which is also referred to as “scheduled bandwidth”. The first panel may be any panel of the plurality of panels 105, e.g., the panel 105-1. In some embodiments, the scheduled bandwidth may be the bandwidth scheduled for the first panel. In some embodiments, the scheduled bandwidth may be the bandwidths for all of the plurality of panels 105.

At block 320, the UE 120 maps the PT-RS to physical resources based on the determined density of PT-RS to be transmitted. At block 330, the UE 120 transmits, the PT-RS via the transceiver from the first panel to the network by using the mapped physical resources. Acts performed with respect to blocks 310, 320 and 330 may depend on whether transform precoding is enabled. Example embodiments where the transform precoding is enabled and example embodiments where the transform precoding is not enabled are described below in detail, respectively.

### Example Embodiments Where Transform Precoding is Enabled

In some embodiments, transform precoding is enabled. For example, the DFT-s-OFDM waveform is used for transmission. For the DFT-s-OFDM waveform, the PT-RS and data are multiplexed within symbols before DFT. In this case, at block 310, the UE may determine a density of PT-RS within a symbol and a symbol level PT-RS density. The symbol level PT-RS density refers to the frequency of PT-RS across symbols and may be configured by higher layer signaling, e.g., Radio Resource Control (RRC) signaling from the BS 110. The density of PT-RS within a symbol which is also referred to as “PT-RS density per panel” may refer to the number of PT-RS groups within a symbol and the number of PT-RS samples in a PT-RS group.

FIG. 4 illustrates a schematic diagram 400 of the density of PT-RS within a symbol according to some embodiments of the present disclosure. In the example as shown in FIG. 4, there are four PT-RS groups 411, 412, 413 and 414 within the modulated symbol 210. Each PT-RS group comprises four PT-RS samples. For example, the PT-RS group 411 comprises four PT-RS samples 421, 422, 423 and 424.

In some embodiments, the UE 120 may determine the density of PT-RS to be transmitted from each panel based on a threshold and a bandwidth. A specific bandwidth for determining the density of PT-RS may be selected differently in different options.

In some embodiments, option 1 may be applied. In option 1, the PT-RS density per symbol may be determined based on the scheduled bandwidth per panel and a threshold. The scheduled bandwidth per panel may be the number of allocated RBs within a DFT window. For example, the PT-RS density per symbol for the panel 105-1 may be determined based on the scheduled bandwidth for the panel 105-1 and a threshold.

In some embodiments, option 2 may be applied. In option 2, the PT-RS density per symbol may be determined based on a representative bandwidth for all the panels and a threshold. The representative bandwidth may be determined based on the scheduled bandwidth for all the panels. As an example, the representative bandwidth may be a total bandwidth of bandwidths scheduled for the plurality of panels 105. Alternatively, the representative bandwidth may be an average bandwidth of bandwidths scheduled for the plurality of panels 105. Alternatively, the representative bandwidth may be a maximum bandwidth among bandwidths scheduled for the plurality of panels 105. Alternatively, the representative bandwidth may be a minimum bandwidth among bandwidths scheduled for the plurality of panels 105.

For both option 1 and option 2, the threshold used by the UE 120 to determine the density of PT-RS may be configured by a higher layer signaling, for example, a RRC signaling. The threshold may be common or dedicated for different multiplexing schemes for different panels. Alternatively, the UE 120 may report one or more recommend thresholds according to the capability of the UE 120.

In some embodiments, option 3 may be applied. In option 3, the UE 120 may report to the BS 110 how to determine the density of PT-RS within a symbol. For example, the UE 120 may report whether to apply option 1 or option 2 for determining the PT-RS density. Alternatively, the BS 110 may configure how to determine the density of PT-RS within a symbol. For example, the BS 110 may configure whether to apply option 1 or option 2 for determining the PT-RS density by a RRC signaling.

The UE 120 can support one or more of the above options 1, 2 and 3. Moreover, different options may be applied to different multiplexing schemes, such as the FDM mode, the SDM mode or the hybrid FDM/SDM mode.

As an example, the UE 120 may determine the density of PT-RS within a symbol based on a table. The table may indicate the relationship between the scheduled bandwidth(s) for at least one of the plurality panels 105 and the density of PT-RS within a symbol. The following Table 1 is an example for illustration.

TABLE 1
PT-RS group pattern as a function of scheduled bandwidth

| | | Number of samples |
|---|---|---|
| Scheduled bandwidth | Number of PT-RS groups | per PT-RS group |
| N_{RB0} ≤ N_{RB, x} < N_{RB1} | 2 | 2 |
| N_{RB1} ≤ N_{RB, x} < N_{RB2} | 2 | 4 |
| N_{RB2} ≤ N_{RB, x} < N_{RB3} | 4 | 2 |
| N_{RB3} ≤ N_{RB, x} < N_{RB4} | 4 | 4 |
| N_{RB4} ≤ N_{RB, x} | 8 | 4 |

In Table 1, N_{RB0}, N_{RB1}, N_{RB2}, N_{RB3}, N_{RB3}, N_{RB4} denote the thresholds as mentioned above, and the N_{RB, x} denotes the bandwidth for panel x as mentioned above.

In the embodiments where option 1 is applied, N_{RB, x} denotes the scheduled bandwidth for a panel x. For example, the scheduled bandwidth for the panel 105-1.

In the embodiments where option 2 is applied, the N_{RB, x} denotes the representative bandwidth for the plurality of panels 105. It is assumed that there are two panels with indices 1 and 2. As mentioned above, the representative bandwidth may be a total bandwidth of bandwidths scheduled for the plurality of panels. In this case, the N_{RB, x} may be defined as N_{RB, x}=N_{RB, 1}+N_{RB, 2} if there are only two panels. Similarly, N_{RB, x} may be defined as N_{RB, x}=ceil((N_{RB, 1}+N_{RB, 2})/2) or N_{RB, x}=floor((N_{RB, 1}+N_{RB, 2})/2) if the representative bandwidth is an average bandwidth of bandwidths. Similarly, N_{RB, x} may be defined as N_{RB, x}=min(N_{RB, 1}, N_{RB, 2}) if the representative bandwidth is a minimum bandwidth of bandwidths. Similarly, N_{RB, x} may be defined as N_{RB, x}=max(N_{RB, 1}, N_{RB, 2}) if the representative bandwidth is a maximum bandwidth of bandwidths if there are two panels.

In this way, the density of a PT-RS to be transmitted from each panel of a plurality of panels 105 may be determined. In contrast to determining the density of PT-RS for the UE 120, different scheduled bandwidths for different panels may be considered. As such, better compensation for the phase offset in each panel may be achieved.

At block 320, the UE 120 may map the PT-RS to physical resources based on the determined density of PT-RS. In other words, the UE 120 may map the PT-RS to be transmitted from each panel to corresponding physical resources. Taking the panel 105-1 as an example, the UE 120 may determine an index of each PT-RS sample in the PT-RS groups based on the number of PT-RS groups, the number of PT-RS samples, and the number of subcarriers scheduled for the panel 105-1. The number of subcarriers scheduled for the panel 105-1 is the same as the size of DFT. In this way, after determining the PT-RS density, the PT-RS and data multiplexing pattern can be determined based on the size of DFT, i.e., the number of subcarriers scheduled for a panel.

The number of PT-RS groups and the number of PT-RS samples per group may be determined as discussed above. However, it is to be understood that, even if the density of PT-RS within a symbol is determined based on all of the plurality of panels 105, the index of each PT-RS sample in the PT-RS groups may be determined based on the number of subcarriers for the respective panel.

As an example, the UE 120 may determine the index of each PT-RS sample in the PT-RS groups according to Table 2 as follows.

TABLE 2
PT-RS symbol mapping.

| Number | Number of | |
|---|---|---|
| of PT-RS | samples per | |
| groups | PT-RS | Index m of PT-RS samples in OFDM symbol |
| N_{group}^{PT-RS} | group Nₛₐₘₚ^{group} | l prior to transform precoding |
| 2 | 2 | s└M_{sc}^{PUSCH}/4┘ + k − 1 where s = 1, 3 and k = 0, 1 |
| 2 | 4 | ${sM}_{sc}^{PUSCH} + k where \{ \begin{matrix}s = 0 & and & k = 0 , 1 , 2 , 3 \\ s = 1 & and & k = - 4 , - 3 , - 2 , - 1\end{matrix}$ |
| 4 | 2 | └s M_{sc}^{PUSCH}/8┘ + k − 1 where s = 1, 3, 5, 7 and k = 0, 1 |
| 4 | 4 | ${sM}_{sc}^{PUSCH} / 4 + n + k where$ $\{ \begin{matrix}s = 0 & and & k = 0 , 1 , 2 , 3 & n = 0 \\ s = 1 , 2 & and & k = - 2 , - 1 , 0 , 1 & n = ⌊ {M}_{sc}^{PUSCH} / 8 ⌋ \\ s = 4 & and & k = - 4 , - 3 , - 2 , - 1 & n = 0\end{matrix}$ |
| 8 | 4 | $⌊ {sM}_{sc}^{PUSCH} / 8 ⌋ + n + k where$ $\{ \begin{matrix}s = 0 & and & k = 0 , 1 , 2 , 3 & n = 0 \\ s = 1 , 2 , 3 , 4 , 5 , 6 & and & k = - 2 , - 1 , 0 , 1 & n = ⌊ {M}_{sc}^{PUSCH} / 16 ⌋ \\ s = 8 & and & k = - 4 , - 3 , - 2 , - 1 & n = 0\end{matrix}$ |

In Table 2, M_{sc}^{PUSCH} denotes the number of subcarriers per panel, i.e., the size of DFT. As can be seen from Table 2, the index m of each PT-RS sample in the PT-RS groups may be determined based on the number of PT-RS groups Nₛₐₘₚ^{group}, the number of samples N_{group}^{PT-RS} in a PT-RS group, M_{sc}^{PUSCH} and some other variables like s, k, and n.

Based on the determined index m, the number of PT-RS groups and the number of PT-RS samples determined at block 310, and the number of subcarriers scheduled for the respective panel, the UE 120 may map each PT-RS sample to a subcarrier of the subcarriers scheduled for the respective panel by performing a DFT on the PT-RS samples with the indices m. As mentioned above, in contrast to mapping the PT-RS samples to the subcarriers scheduled for a UE as in conventional solutions, the UE 120 may map the PT-RS samples to the subcarriers scheduled for the respective panel. In this way, the UE 120 can map the PT-RS to the physical resources for transmitting the PT-RS.

The UE 120 may generate a sequence rₘ for PT-RS that is mapped in position m. The position m may correspond to the index m as mentioned above. The position m may also depend on the number of PT-RS groups, the number of samples per PT-RS group and M_{sc}^{PUSCH} according to Table 2. The sequence rₘ of PT-RS may be determined based on the index m within a DFT window.

In some embodiments, the UE 120 may generate sequences corresponding to the PT-RS samples in the PT-RS groups based on an identity (ID) of the respective panel. The ID of the respective panel may be configured by the BS 110. For example, the ID may be configured by higher layer signaling. The IDs of different panels may be different. Alternatively, the IDs of all the plurality of panels may be the same. In this case, the UE 120 may generate the sequences corresponding to the PT-RS samples in the PT-RS groups based on a common ID.

As an example, the sequence rₘ of PT-RS may be generated according to the following equation (1).

$${r}_{m} ( {m}^{′} ) = w ( {k}^{′} ) \frac{{e}^{j \frac{π}{2} ( m mod 2 )}}{\sqrt{2}} [ ( 1 - 2 c ( {m}^{′} ) ) + j ( 1 - 2 c ( {m}^{′} ) ) ] \qquad ( 1 )$$

$${m}^{′} = {N}_{samp}^{group} {s}^{′} + {k}^{′}$$

$${s}^{′} = 0 , 1 , … , {N}_{group}^{PT - RS} - 1$$

$${k}^{′} = 0 , 1 , {N}_{samp}^{group} - 1$$

where the pseudo-random sequence c(i) may be initialized with cᵢₙᵢₜ and cᵢₙᵢₜ may be defined by equation (2).

cᵢₙᵢₜ=(2¹⁷(N_{symb}^{slot}n_{s,f}^{μ}+l +1)(2N_{ID}^{x}+1)+2N_{ID}^{x})mod2³¹ (2)

where N_{symb}^{slot} indicates the number of symbols per slot, n_{s,f}^{μ}indicates slot index, l indicates symbol index as shown in Table 2, and N_{ID}^{x} indicates the ID of a panel x. Please be noted that N_{ID}^{x} may be the same for all of the plurality of panels 105.

As such, the sequence rₘ of PT-RS can be generated according to equations (1) and (2). The UE 120 may then transmit the generated sequences from each panel to the network by using the corresponding mapped physical resources.

Additionally, in some embodiments, the UE 120 may determine a power scaling factor for the PT-RS and transmit the PT-RS from the respective panel with a power scaled by the power scaling factor. As such, the transmission power of the UE 120 may be scaled. The UE 120 may determine the power scaling factor based on MCS indicated for at least one of the plurality of panels 105. Please be noted that, different MCSs may be indicated for different panels.

In some embodiments, the power scaling factor for PT-RS in each panel may be determined based on a specific MCS indicated for the respective panel. For example, the power scaling factor for PT-RS in the panel 105-1 may be determined based on the MCS indicated for the panel 105-1. Similar, the power scaling factor for PT-RS in the panel 105-2 may be determined based on the MCS indicated for the panel 105-2.

In some embodiments, the power scaling factor for PT-RS in each panel may be determined based on a representative MCS of MCSs indicated for all the panels 105. In this case, the power scaling factor for all the panels 105 is the same. For example, the representative MCS may be a MCS with the highest index among MCSs indicated for the plurality of panels 105. Alternatively, the representative MCS may be a MCS with the lowest index among MCSs indicated for the plurality of panels 105.

As an example, the UE 120 may determine the power scaling factor for the PT-RS in a panel based on the following Table 3. In this case, “the scheduled modulation for a panel” as shown in Table 3 is determined based on the index of the indicated MCS for the respective panel.

TABLE 3
PT-RS scaling factor (β′) when transform precoding enabled.

| Scheduled modulation for a panel | PT-RS scaling factor (β′) |
|---|---|
| π/2-BPSK | 1 |
| QPSK | 1 |
| 16QAM | 3/\sqrt{5} |
| 64QAM | 7/\sqrt{21} |
| 256QAM | 15/\sqrt{85} |

Alternatively, the UE 120 may determine the power scaling factor for the PT-RS in all the panels based on the Table 3. In this case, “the scheduled modulation for a panel” as shown in Table 3 is the scheduled modulation determined based on the index of the representative MCS as discussed above.

### Example Embodiments Where Transform Precoding is Not Enabled

In some embodiments, transform precoding is not enabled. For example, the CP-OFDM waveform is used for uplink transmission. In this case, at block 310, the UE 120 may determine a frequency domain density of the PT-RS and a time domain density of the PT-RS. The frequency domain density of the PT-RS may refer to the density of PT-RS across different RBs. The time domain density of the PT-RS may refer to the density of PT-RS across different symbols.

The UE 120 may determine the frequency domain density of the PT-RS based on a threshold and a bandwidth. The bandwidth for determining the frequency domain density of the PT-RS may be selected differently in different options.

In some embodiments, option 1 may be applied. In option 1, the frequency domain density of the PT-RS may be determined based on the scheduled bandwidth per panel. For example, the frequency domain density of the PT-RS to be transmitted from the panel 105-1 may be determined based on a scheduled bandwidth for the panel 105-1. The scheduled bandwidth for the panel 105-1 may be the number of allocated RBs for the panel 105-1.

In some embodiments, option 2 may be applied. In option 2, the frequency domain density of the PT-RS may be determined based on a representative bandwidth. The representative bandwidth may be determined based on the scheduled bandwidths for all the panels of the UE 120. As an example, the representative bandwidth may be a total bandwidth of bandwidths scheduled for the plurality of panels 105. Alternatively, the representative bandwidth may be an average bandwidth of bandwidths scheduled for the plurality of panels 105. Alternatively, the representative bandwidth may be a maximum bandwidth among bandwidths scheduled for the plurality of panels 105. Alternatively, the representative bandwidth may be a minimum bandwidth among bandwidths scheduled for the plurality of panels 105.

For both option 1 and option 2, the threshold used by the UE 120 to determine the frequency domain density may be configured by a higher layer signaling, for example, a RRC signaling. The threshold may be common or dedicated for different multiplexing schemes for different panels. Alternatively, the UE 120 may report one or more recommend thresholds according to the capability of the UE 120.

In some embodiments, option 3 may be applied. In option 3, the UE 120 may report to the BS 110 how to determine the frequency domain density of the PT-RS. For example, the UE 120 may report whether to apply option 1 or option 2 for determining the frequency domain density. Alternatively, the BS 110 may configure how to determine the frequency domain density of the PT-RS. For example, the BS 110 may configure whether to apply option 1 or option 2 for determining the frequency domain density of the PT-RS by a RRC signaling.

The UE 120 can support one or more of the above options 1, 2 and 3 to determine the frequency domain density. Moreover, different options may be applied to different multiplexing schemes, such as the FDM mode, the SDM mode or the hybrid FDM/SDM mode.

The UE 120 may determine the time domain density of the PT-RS based on a threshold and a MCS indicated for at least one of the plurality of panels 105. The MCS for determining the time domain density of the PT-RS to be transmitted from a panel may be referred to as a specific MCS for this panel.

In some embodiments, option 1 may be applied. In option 1, the time domain density of the PT-RS may be determined based on the threshold and the MCS indicated per panel. For example, the time domain density of the PT-RS to be transmitted from the panel 105-1 may be determined based on a scheduled bandwidth for the panel 105-1. The scheduled bandwidth for the panel 105-1 may be the number of allocated RBs for the panel 105-1.

In some embodiments, option 2 may be applied. In option 2, the time domain density of the PT-RS may be determined based on a representative MCS of MCSs indicated for all the panels 105. For example, the representative MCS may be a MCS with the highest index among MCSs indicated for the plurality of panels 105. Alternatively, the representative MCS may be a MCS with the lowest index among MCSs indicated for the plurality of panels 105.

For both option 1 and option 2, the threshold used by the UE 120 to determine the time domain density may be configured by a higher layer signaling, for example, a RRC signaling. The threshold may be common or dedicated for different multiplexing schemes for different panels. Alternatively, the UE 120 may report one or more recommend thresholds according to the capability of the UE 120.

In some embodiments, option 3 may be applied. In option 3, the UE 120 may report to the BS 110 how to determine the time domain density of the PT-RS. For example, the UE 120 may report whether to apply option 1 or option 2 for determining the time domain density of the PT-RS. Additionally, the BS 110 may configure how to determine the time domain density of the PT-RS. For example, the BS 110 may configure whether to apply option 1 or option 2 for determining the time domain density of the PT-RS by a RRC signaling.

In some embodiments, option 4 may be applied. In option 4, the MCSs indicated for uplink transmissions from the plurality of panels 105 may be the same. In this case, the time domain density of the PT-RS for all the panels 105 may be determined based on the same MCS.

The UE 120 can support one or more of the above options 1, 2, 3 and 4 to determine the time domain density. Moreover, different options may be applied to different multiplexing schemes, such as the FDM mode, the SDM mode or the hybrid FDM/SDM mode.

Upon determining the density of PT-RS, at block 320 the UE 120 may map the PT-RS to physical resources. In other words, the UE 120 may map the PT-RS to be transmitted from each panel to corresponding physical resources.

It is to be noted that, if CP-OFDM waveforms are used, multiple PT-RS ports may be supported. In this case, the plurality of panels 105 may share a same PT-RS port to transmit PT-RS or each of the plurality of panels uses 105 its respective PT-RS port to transmit PT-RS.

In some embodiments, for example, if the FDM mode is used, the plurality of panels 105 may share a same PT-RS port. In such embodiments, the PT-RS resource mapping is performed within the bandwidth scheduled for each panel 105. Non-overlapped bandwidths are scheduled for different panels.

In such embodiments, the UE 120 may map the PT-RS to be transmitted from a first panel to the physical resources within a first bandwidth scheduled for the first panel and mapping the PT-RS to be transmitted from a second panel to the physical resources within a second bandwidth scheduled for the second panel. The first bandwidth is non-overlapped with the second bandwidth. In the case where there are more than two panels, the UE 120 may further map PT-RS to be transmitted from other panels and the scheduled bandwidths for these panels are non-overlapped.

In other words, the UE 120 may map the PT-RS to the physical resources within a respective scheduled bandwidth for each panel. For example, the UE 120 may map the PT-RS to the physical resources within a first scheduled bandwidth for the panel 105-1 based on the frequency domain density and the time domain density determined for the panel 105-1. Moreover, the UE 120 may map the PT-RS to the physical resources within a second scheduled bandwidth for the panel 105-2 based on the frequency domain density and the time domain density determined for panel 105-2. In this case, in order to map the PT-RS to the physical resources within a bandwidth scheduled for a respective panel, the UE 120 may determine the location of the PT-RS within the scheduled bandwidth based on the frequency domain density.

In the embodiments where the FDM mode is used, the UE 120 may further determine a power scaling factor for the PT-RS and transmit the PT-RS from a corresponding panel with a power scaled by the power scaling factor. The UE 120 may determine the power scaling factor for the PT-RS based on a DMRS port scheduled within the respective bandwidth. For example, the UE 120 may determine a first power scaling factor for the PT-RS to be transmitted from the panel 105-1 based on the number of DMRS ports scheduled within the first scheduled bandwidth for the panel 105-1. Specifically, the UE 120 may determine the scheduled number of Physical Uplink Shared Channel (PUSCH) layers as the number of DMRS ports scheduled within the first scheduled bandwidth for the panel 150-1. Based on the number of DMRS ports, the UE 120 may determine the PUSCH to PT-RS energy per resource element (EPRE) offset. The UE 120 may determine the power scaling factor for the PT-RS based on the PUSCH to PT-RS EPRE offset. The UE 120 may then transmit the PT-RS from the panel 150-1 with a power scaled by the power scaling factor.

In some embodiments, for example, if the SDM mode or the hybrid FDM/SDM mode is used, each of the plurality of panels may use its respective PT-RS port. Moreover, in the case of the CP-OFDM waveform, the PT-RS may be mapped to symbols without DMRS. Thus, a PT-RS port may need to be associated with a DMRS port for the phase noise compensation to be performed. The association between a PT-RS port and a DMRS port may be indicated by downlink control information (DCI).

In such embodiments, each of the plurality of panels 105 may use its respective PT-RS port to transmit PT-RS. In other words, different PT-RS ports are used for different panels. For example, a first PT-RS port used by a first panel may be different from a second PT-RS port used by a second panel of the plurality of panel. Thus, different resource mapping patterns may be performed for different PT-RS ports. In this case, in order to map the PT-RS to physical resources, the UE 120 may determine at least one DMRS port associated with each PT-RS port used by the respective panel. The UE 120 may determine the associated DMRS port(s) based on DCI from the BS 110. In other words, the UE 120 may determine the DMRS port(s) associated with a respective PT-RS port used by each panel. As mentioned above, the association may be indicated by DCI. The UE 120 may map the PT-RS to the physical resources based on the frequency domain density, the time domain density, a bandwidth scheduled for an uplink transmission corresponding to the associated DMRS port(s) and a MCS indicated for the uplink transmission. As such, the UE 120 may perform the resource mapping per PT-RS port.

In the embodiments where the SDM mode or the hybrid FDM/SDM mode is used, the UE 120 may further determine a power scaling factor for the PT-RS and transmit the PT-RS from a corresponding panel with a power scaled by the power scaling factor. The UE 120 may determine the power scaling factor for the PT-RS based on the number of the at least one DMRS port associated with the PT-RS port. For example, the UE 120 may determine the power scaling factor for the PT-RS based on the PT-RS port and the number of the at least one DMRS port for each panel.

As an example, the UE 120 may determine a power scaling factor for the PT-RS to be transmitted from the panel 105-1 based on the number of associated DMRS port(s) for the panel 105-1. Specifically, the UE 120 may determine the scheduled number of PUSCH layers as the number of DMRS port(s) for the panel 105-1. Based on the number of DMRS port(s), the UE 120 may determine the PUSCH to PT-RS EPRE offset. The UE 120 may determine the power scaling factor for the PT-RS based on the PUSCH to PT-RS EPRE offset. The UE 120 may transmit the PT-RS from the panel 105-1 with a power scaled by the power scaling factor.

In some embodiments, whether the FDM mode is used or the SDM or the hybrid FDM/SDM scheme is used, the UE 120 may generate a sequence of the PT-RS based on a sequence of an associated DMRS port in the same frequency location. For example, the UE 120 may determine the sequence of associated DMRS port as the sequence of PT-RS.

For both the case where the transform precoding is enabled and the case where the transform precoding is not enabled, the PT-RS transmission is supported for phase offset compensation. The UE 120 determines a density of the PT-RS to be transmitted per panel, maps the PT-RS to physical resources based on the determined density and transmits the PT-RS from the respective panel. In both cases, the density of the PT-RS may be determined based on a threshold and a metric of a scheduled bandwidth. The threshold may be reported by the UE 120 or configured by a higher layer signaling. The metric of the scheduled bandwidth may be a specific bandwidth scheduled for a corresponding panel or determined based on the bandwidths scheduled for the plurality of panels.

### Power Control for Multi-panel Transmission

As mentioned above, uplink multi-panel transmission is going to be supported. In multi-panel transmission, uplink signals may be transmitted from different panels. In this case, in addition to different uplink transmissions from one panel overlapped in time, different uplink transmissions from multiple panels may be overlapped in time. As such, when a total transmission power of uplink transmissions from one or more panels exceeds a predetermined maximum transmission power, the UE 120 may need to perform power control on the uplink transmissions to reduce the total transmission power. Conventionally, a UE performs the power control on UE level. Thus, the conventional solution of power control does not consider the different characteristics of different panels. Accordingly, a solution for power control for multi-panel transmission is in demand.

As mentioned above, in multi-panel transmission, different transmissions from one or more panels may be overlapped in time. In the overlapped time period, different types of signals may be transmitted from different panels. For example, signals such as PUSCH, Physical Uplink Control Channel (PUCCH), Physical Random Access Channel (PRACH), and Sounding Reference Signal (SRS) may be transmitted in the overlapped time period. In some embodiments, for example, if carrier aggregation and/or dual connectivity are employed in the network 100, there may be multiple uplink signals from different serving cells in the overlapped time period. For example, some signals may be transmitted from the panel 105-1 for a first serving cell, and some other signals may be transmitted from the panel 105-2 for a second serving cell.

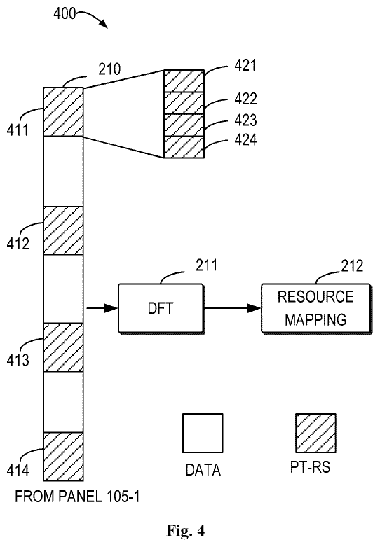

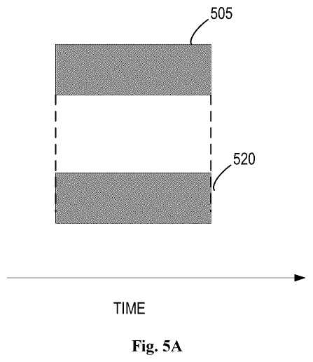

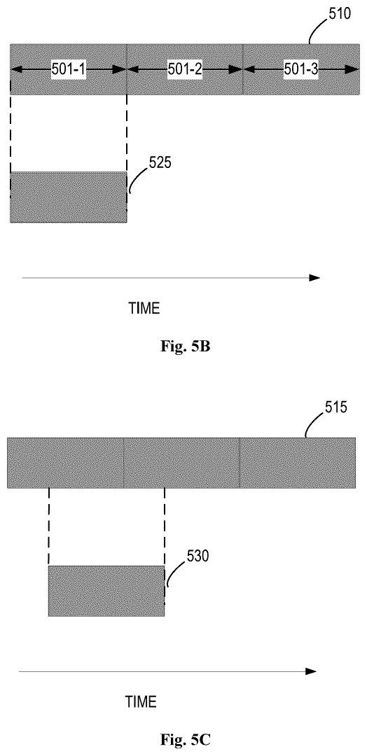

The overlap of uplink transmissions in time may comprise different levels of overlap. FIGS. 5A-5C illustrates schematic diagrams of uplink transmissions overlapped in different levels. FIGS. 5A-5C illustrates multiple uplink transmissions 505, 510, 515, 520, 525 and 530. These transmissions may be from a same panel or different panels. For example, in some embodiments, uplink transmissions 505 and 520 may be from different panels. The uplink transmission 505 may be from the panel 105-1 and the uplink transmission 520 may be from the panel 105-2. Alternatively, in some embodiment, the uplink transmissions 505 and 520 may be from the same panel. For example, both the uplink transmissions 505 and 520 may be from the panel 105-1. In this case, the uplink transmissions 505 and 520 may be transmissions of different types of signals.

The uplink transmission 510 as shown in FIG. 5B is a transmission instance comprising transmissions over different transmission occasions 510-1, 510-2 and 510-3. As used herein, a transmission occasion may refer to a transmission unit where the BS 110 may decode the corresponding uplink signal independently. A transmission occasion may be one slot, several symbols or the like. The transmission instance and transmission occasion for different uplink transmissions may be different. As shown in FIGS. 5A-5C, the regions defined between dashed lines represent the overlapped time period.

In some embodiments, the uplink transmissions may be fully overlapped in time domain (referred as Case 1 hereafter). As shown in FIG. 5A, the uplink transmission 505 is fully overlapped with the uplink transmission 520 in time domain. In this case, the overlap may be in transmission level.

In some embodiments, the uplink transmissions may be partially overlapped in time domain (referred as Case 2 hereafter). For example, the uplink transmissions may be overlapped in transmission occasion level (referred as Case 2-1 hereafter). In other words, the overlap may be in N (N=1, 2, 3 . . . ) transmission occasions. As shown in FIGS. 5B, the uplink transmission 510 may be partially overlapped with the uplink transmission 525 over one transmission occasion. As another example, the uplink transmissions may be overlapped in other levels (referred as Case 2-2 hereafter). The overlap in other levels may refer to the overlap across several symbols or within a symbol, instead of the overlap in one or more full transmission occasion(s). As shown in FIG. 5C, the uplink transmission 515 may be overlapped with the uplink transmission 530 over several symbols within a transmission occasion.

In the overlapped time period, a total transmission power of a plurality of transmissions may exceed a maximum transmission power. In some embodiments, the total transmission power of overlapped transmission may be higher than a maximum transmission power P_{UE} of the UE 120. For example, the total transmission power of overlapped transmissions from one panel may exceed the maximum transmission power P_{UE} of the UE 120. As another example, the total transmission power of overlapped transmissions from all panels may exceed the maximum transmission power P_{UE} of the UE 120. Alternatively, the total transmission power of overlapped transmissions from several panels may exceed the maximum transmission power P_{UE} of the UE 120. In some embodiments, the total transmission power of overlapped transmission from one panel may exceed a maximum transmission power P_{PANEL} for the respective panel. In these cases, the UE 120 may need to select transmission(s) on which power reduction is to be performed and how to perform the power reduction on the selected transmission(s).

### Power Control Per Panel

A first solution for power control for multi-panel transmission is to maintain a maximum transmission power for each panel. In the first solution, power control is performed per panel. Accordingly, the maximum transmission power of each of the plurality of panels 105 may be reported by the UE 120. The UE 120 may report a respective maximum transmission of each panel based on a maximum transmission power of the UE 120. For example, the UE 120 may ensure that the maximum transmission power of each panel is lower than the maximum transmission power of the UE 120. In some embodiments, the UE 120 may ensure that a sum of the maximum transmission powers of all panels 105 is lower than the maximum transmission power of the UE 120.

In this solution, the UE 120 performs power control for a panel when a total transmission power from this panel is above its maximum transmission power. In other words, the UE 120 determines whether a total transmission power of a plurality of uplink transmissions to be performed from a given panel of the UE exceeds a maximum transmission power of the given panel. The plurality of uplink transmissions are overlapped in time. The UE 120 reduces a transmission power of a first uplink transmission of the plurality of uplink transmissions to reduce the total transmission power if the total transmission power exceeds the maximum transmission power. The first uplink transmission has a lower priority than a second uplink transmission of the plurality of uplink transmissions. The UE 120 then causes the plurality of uplink transmissions to be performed from the given panel with the reduced total transmission power. In this way, the UE 120 may ensure that the total transmission power in each panel is lower than the respective maximum transmission power.

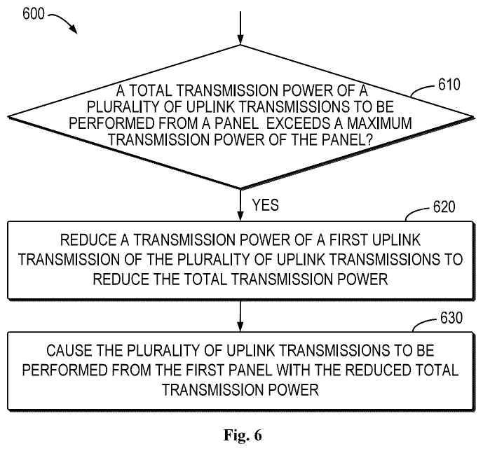

Reference is now made to reference to FIG. 6. FIG. 6 illustrates a flowchart illustrating an example method 600 of power control for multi-panel transmission according to some embodiments of the present disclosure. For the purpose of discussion, the method 600 will be described with reference to FIGS. 1 and 5. The method 600 may involve the UE 120 shown in FIG. 1.

At block 610, the UE 120 determines whether a total transmission power of a plurality of uplink transmissions to be performed from a panel of the UE 120 exceeds a maximum transmission power of the panel. The plurality of uplink transmissions are overlapped in time and may be referred to as “overlapped uplink transmissions”. The panel may refer to any panel of the plurality of panels 105. For the purpose of illustration without any limitation to the protection scope, the panel 105-1 is taken as an example in the following. However, it is to be understood that similar power control can be applied to the panel 150-2.

The plurality of uplink transmissions overlapped in time may refer to a group of overlapped transmissions as described above in Case 1 and Case 2. For the purpose of illustration, it is assumed here that the multiple transmissions as shown in FIGS. 5A-5C are all to be performed from the panel 105-1. As an example, the plurality of uplink transmissions may refer to the uplink transmissions 505 and 520 shown in FIG. 5A. As another example, the plurality of uplink transmissions may refer to the uplink transmissions 510 and 525 shown in FIG. 5B. As a further example, the plurality of uplink transmissions may refer to the uplink transmissions 515 and 530 shown in FIG. 5C.

If at block 610, the total transmission power from the panel 105-1 is determined as exceeding the maximum transmission power of the panel 105-1, the method 600 proceeds to block 620. At block 620, the UE 120 reduces a transmission power of a first uplink transmission of the plurality of uplink transmissions to reduce the total transmission power of the first panel. In the following, one or more uplink transmission on which power reduction is performed or is to be performed is also referred to as a “target uplink transmission”. Thus, the first uplink transmission is selected as a target uplink transmission. The UE 120 determines a transmission having a lower priority as the first uplink transmission. The first uplink transmission has a lower priority than a second uplink transmission of the plurality of uplink transmissions. For example, the first uplink transmission may have the lowest priority among the plurality of uplink transmissions.

The UE 120 may determine the target uplink transmission based on a priority order of the plurality of uplink transmissions. The priority of each uplink transmission may be determined based on the characteristics of the transmission.

As an example, the UE 120 may determine the priorities of the uplink transmissions based on channel types of the plurality of uplink transmissions. The types of the plurality of uplink transmissions may comprise PUSCH, PRACH, SRS, PUCCH and the like. Alternatively or in addition, the UE 120 may determine the priorities based on the information carried by the plurality of uplink transmissions. The carried information may comprise Scheduling Request (SR), Hybrid Automatic Repeat Request Acknowledgement (HARQ-ACK) and Channel State Information (CSI). Alternatively or in addition, the UE 120 may determine the priorities based on the traffic types of the plurality of uplink transmissions. For example, the traffic types may comprise Ultra Reliable and Low Latency Communication (URLLC), Enhanced Mobile Broadband (eMBB) and the like. Alternatively or in addition, the UE 120 may determine the priorities based on the periodicities of the plurality of uplink transmissions, or in other words, time domain behaviors of the plurality of uplink transmissions. Example transmissions with the periodicities may comprise an aperiodic transmission, a semi-persistent transmission and a periodic transmission. Alternatively or in addition, the UE 120 may determine the priorities based on the serving cells of the plurality of uplink transmissions. For example, a serving cell may be a primary cell (PCell) or a secondary cell (SCell).

In some embodiments, two or more of the above characteristics of the uplink transmissions may be combined. An example priority order is shown in descending order as follows.
Priority group 1: PRACH transmission on the PCell
Priority group 2: PUCCH transmission with HARQ-ACK information and/or SR or PUSCH transmission with HARQ-ACK information
Priority group 3: PUCCH transmission with CSI or PUSCH transmission with CSI
Priority group 4: PUSCH transmission without HARQ-ACK information or CSI
Priority group 5: SRS transmission, with aperiodic SRS having higher priority than semi-persistent and/or periodic SRS, or PRACH transmission on a serving cell other than the PCell

As an example, the first uplink transmission with a lower priority may be a PUSCH transmission without HARQ-ACK information or CSI in Priority group 2 while the second uplink transmission may be a transmission in Priority group 1. It is to be understood that the above priority order is merely for the purpose of discussion without any limitation on the protection scope.

In some embodiments, the plurality of uplink transmissions may be fully overlapped over the all transmission occasions, as Case 1 described above. In such embodiments, the UE 120 may reduce the transmission power for the whole transmission occasion of the target uplink transmission. For example, as shown in FIG. 5A, the uplink transmissions 505 and 520 are fully overlapped. If the uplink transmission 505 has a lower priority than the uplink transmission 520, the UE 120 may reduce the transmission power of the uplink transmission 505 over all of the transmission occasions.

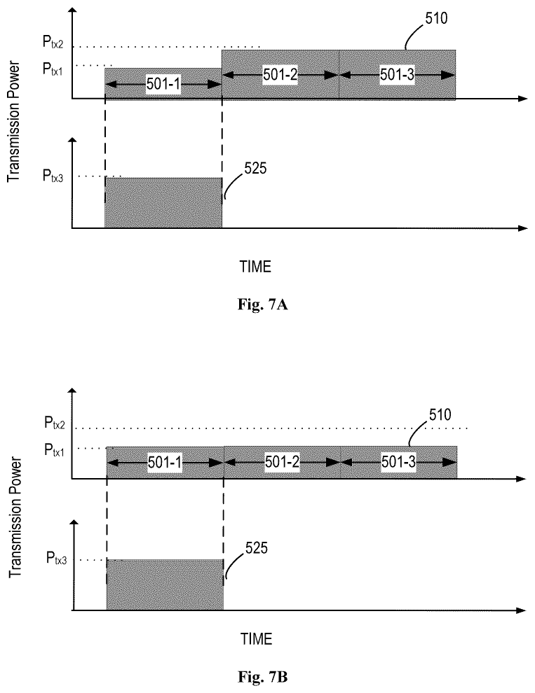

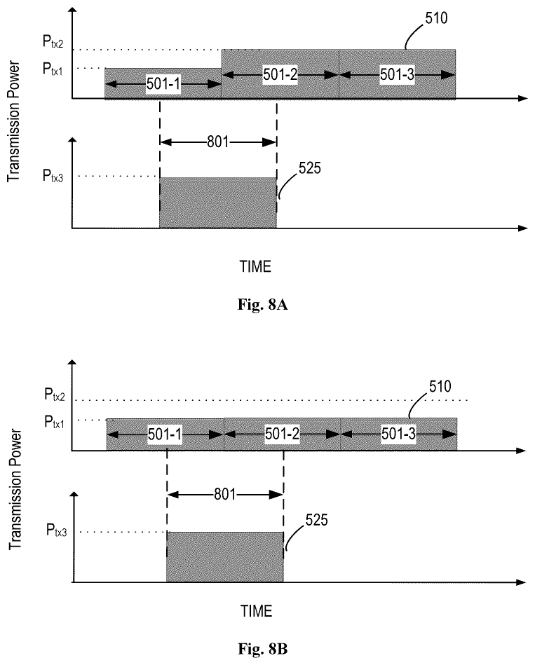

In some embodiments, the plurality of uplink transmissions may be partially overlapped, for example, overlapped in transmission occasion level (as Case 2-1 described above) or in other levels (as Case 2-2 described above). Power reduction in such embodiments is now described with reference to FIGS. 7A, 7B, 8A and 8B. FIG. 7A and FIG. 7B illustrate examples of power reduction in the case where the uplink transmissions are overlapped in transmission occasion level according to some embodiments of the present disclosure. FIG. 8A and FIG. 8B illustrate examples of power reduction in the case where the uplink transmissions are overlapped in other levels according to some embodiments of the present disclosure.

In some embodiments, the UE 120 may reduce the transmission power of the target uplink transmission over at least one transmission occasion, over which the plurality of uplink transmissions is at least partially overlapped. Specifically, the UE 120 may perform power reduction on the target uplink transmission(s) only over the overlapped transmission occasion(s) (referred as “power reduction option 1” hereafter). In other words, the UE 120 may reduce the transmission power for the overlapped transmission occasion(s). For example, as shown in FIG. 7A, the plurality of transmissions may be overlapped only in transmission occasion 501-1 and the uplink transmission 510 is determined as the target uplink transmission. Accordingly, power reduction is performed on the uplink transmission 510 only over the transmission occasion 501-1. The transmission power over the transmission occasion 501-1 is reduced from Pₜₓ₂ to Pₜₓ₁. As another example, as shown in FIG. 8A, the plurality of transmissions are overlapped over an overlapped time period 801 comprising several symbols of the transmission occasions 501-1 and 501-2. The uplink transmission 510 is determined as the target uplink transmission. Accordingly, power reduction is perform on the uplink transmission 510 only over the transmission occasions 501-1 and 501-2. The transmission power over the occasions 501-1 and 501-2 is reduced from Pₜₓ₂ to Pₜₓ₁.

Alternatively, in some embodiments, the UE 120 may reduce the transmission power for all transmission occasions of the target uplink transmission. Specifically, the UE 120 may perform power reduction on the target uplink transmission over all transmission occasions within a transmission instance if the overlap occurs over a transmission occasion within the transmission instance (referred as “power reduction option 2” hereafter). In other words, the UE 120 may reduce the transmission power of the target uplink transmission over all transmission occasions within the transmission instance. For example, as shown in FIG. 7B, the plurality of transmissions are overlapped only in the transmission occasion 501-1 and the uplink transmission 510 is determined as the target uplink transmission. In this case, power reduction is performed on the uplink transmission 510 over all the transmission occasions 501-1, 501-2 and 501-3. The transmission power over the transmission occasions 501-1, 501-2 and 501-3 is reduced from Pₜₓ₂ to Pₜₓ₁. As another example, as shown in FIG. 8B, the plurality of transmissions is overlapped in the overlapped time period 801 and the uplink transmission 510 is determined as the target uplink transmission. In this case, the power reduction is performed on the uplink transmission 510 over all transmission occasions 501-1, 501-2 and 501-3 within the transmission instance. The transmission power over the transmission occasions 501-1, 501-2 and 501-3 is reduced from Pₜₓ₂ to Pₜₓ₁.

In some embodiments, the UE 120 may determine how to perform the power reduction on the target uplink transmission based on the higher layer signaling (referred as “power reduction option 3” hereafter). The higher layer signaling may be indicated by the BS 110. For example, the BS 110 may configure the UE 120 whether to apply the power reduction option 1 or the power reduction option 2 as described above. The BS 110 may determine the selection of the power reduction option 1 or the power reduction option 2 based on whether cross-slot channel estimation is to be applied. For example, if the cross-slot channel estimation is to be applied, the power reduction option 2 may be adopted to ensure that the cross-slot channel estimation can be performed on transmissions over different transmission occasions. In this situation, the BS 110 may configure the UE 120 to perform the power reduction by applying the power reduction option 2. Please be noted that, the power reduction option 3 may be applied for power reduction in transmissions overlapped in both transmission level and other levels.

Referring back to FIG. 6, at block 630, the UE 120 causes the plurality of uplink transmissions to be performed from the panel 105-1 with the reduced total transmission power. As shown in FIGS. 7A, 7B, 8A and 8B, the UE 120 may perform the uplink transmission 510 with the reduced transmission power Pₜₓ₁ from the panel 105-1. In this way, the total transmission power of the panel 105-1 may be maintained under its maximum transmission power. Similarly, if the UE determines that the total transmission power of transmissions from the panel 105-2 exceeds the maximum transmission power of the panel 105-2, the UE 120 may perform similar operations for power control.

In some embodiments, the UE 120 may further determine a power headroom (PH) for each panel of the plurality of panels 105 of the UE 120. The plurality of panels may comprise the first panel as discussed above, e.g., panel 105-1. The PH may refer to the difference between the maximum transmission power Pₚₐₙₑₗ for a panel and a current transmission power for this panel. For example, if it is assumed that both the uplink transmissions 510 and 525 are from the panel 105-1, the current transmission power for the panel 105-1 is Pₜₓ₃+Pₜₓ₁. Thus, the UE 120 may determine a first PH for the panel 105-1 as Pₚₐₙₑₗ₋₁₀₅₋₁−Pₜₓ₁−Pₜₓ₃. Similarly, the UE 120 may determine a PHR for each other panel in the plurality of panels 105, for example, the panel 150-2.

In some embodiments, the UE 120 may transmit at least one of the PHs determined for the plurality of panels 105 to the BS 110. The UE 120 may report the PH(s) to the BS 110 via PH report (PHR) for configuring parameters of power control. For example, the UE 120 may transmit N (N=1, 2, 3 . . . ) PHRs for N panels to the BS 110.

In the embodiments where the uplink transmissions are partially overlapped, the power reduction may be performed on the target uplink transmission over at least one transmission occasion. Thus, there may be a transmission occasion with power reduction and a transmission with initial power (that is, without power reduction) in the target uplink transmission. In this case, the UE 120 may determine the PHR based on the transmission occasions with or without power reduction. In other words, the UE 120 may determine a PHR of the panel 105-1 based on specific transmission occasions.

As an example, the UE 120 may determine the PHR of the panel 105-1 based on the at least one transmission occasion with power reduction. Alternatively, or in addition, the UE 120 may determine the PHR of the panel 105-1 based on a further transmission occasion of the target uplink transmission without power reduction. The UE 120 may transmit to the BS 110 both the PHR with power reduction and the PHR without the power reduction. Alternatively, or in addition, the UE 120 may determine the PHR of the panel 105-1 based on a predetermined transmission occasion of the target uplink transmission. The predetermined transmission occasion may be the first or last transmission occasion regardless of whether its power is scaled or not.

In such embodiments, the UE 120 may transmit two PHRs to the BS 110. One PHR may be determined based on the transmission occasion with power reduction, e.g., Pₚₐₙₑₗ₋₁₀₅₋₁−Pₜₓ₁−Pₜₓ₃. The other PHR may be determined based on the transmission occasion without power reduction, e.g., Pₚₐₙₑₗ₋₁₀₅₋₁−Pₜₓ₂−Pₜₓ₃. Alternatively or in addition, the UE 120 may report the PHR for a predetermined transmission occasion regardless of whether its transmission power is reduced or not. The predetermined transmission occasion may be the first or last transmission occasion.

In some embodiments, instead of directly transmitting determined PHRs, the UE 120 may determine power information concerning the plurality of panels 105 and transmit the power information to the BS 110. The power information may be determined based on at least one of the determined PHRs for all the panels 105. For example, the UE 120 may determine the power information based on a sum of PHRs determined for the plurality of panels 105. Alternatively or in addition, the UE 120 may determine the power information based on an average of the PHRs determined for the plurality of panels 105. Alternatively or in addition, the UE 120 may determine the power information based on a minimum PHR among the PHRs determined for the plurality of panels 105. Alternatively or in addition, the UE 120 may determine the power information based on a maximum PHR among the PHRs determined for the plurality of panels 105.

In some embodiments, the UE 120 may differentiate Case 2-1 and Case 2-2 based on a timing advance (TA) value. For example, the UE 120 may report the TA value for different uplink transmissions to the BS 110. As such, the BS 110 may determine whether some transmission occasions are partially overlapped in time domain. As another example, the UE 120 may differentiate Case 2-1 and Case 2-2 based on the TA command indicated for the BS 110.

To differentiate uplink transmissions from different panels, a correspondence between a panel from which a signal is transmitted and a beam used to transmit the signal may be needed. In some embodiments, the correspondence may be reported by the UE 120 based on PUCCH/PUSCH/or MAC CE.

As an example, the UE 120 may transmit, to the BS 110, a first indication of a beam corresponding to each of the plurality of panels 105 of the UE 120. For example, the beam corresponding to the panel 105-1 is reported to the BS 110. In other words, the UE 120 may report a potential panel for each beam index. The beam index may be represented by a SSB resource indicator (SSBRI), a CSI-RS resource indicator (CRI), a SRS resource set or a SRS resource index. The UE 120 may further receive, from the BS 110, a second indication that the beam corresponding to the panel 105-1 is to be used for the plurality of uplink transmissions. Upon receiving the second indication, the UE 120 may know which beam to be used for each transmission.

In some embodiments, the UE 120 may use an indicated panel for transmitting a signal. The panel for the transmission may be indicated by the BS 110 through a higher layer signaling (such as RRC or MAC CE) or DCI.

As an example, the UE 120 may receive, from the BS 110, a third indication of a beam corresponding to each of the plurality of panels 105 of the UE 120. For example, the beam corresponding to the panel 105-1 is indicated by the BS 110. In other words, the UE 120 may receive a panel index provided for uplink beam indication signaling. The uplink beam indication signaling may be a transmission configuration indicator (TCI) or spatial relation information. The UE 120 may further receive, from the BS 110, a fourth indication that the beam corresponding to the panel 105-1 is to be used for the plurality of uplink transmissions. Upon receiving the fourth indication, the UE 120 may know which beam to be used for a transmission.

### Power Control Across Multiple Panels

A second solution for power control for multi-panel transmission is to maintain maximum transmission power for the UE 120. In the second solution, power control is performed across the plurality panels 105 of the UE 120. In this solution, the UE 120 performs power control for at least one of the overlapped uplink transmissions from the plurality of panels 105 if a total transmission power of the UE 120 is above a maximum transmission power of the UE 120. In other words, the UE 120 determines whether a total transmission power of the plurality of uplink transmissions to be performed by the UE 120 exceeds the maximum transmission power of the UE 120. The plurality of uplink transmissions are overlapped in time. The UE 120 further reduces the transmission power of a target uplink transmission to be performed from at least one of the plurality of panels 105 to reduce the total transmission power if the total transmission power exceeds the maximum transmission power. The UE 120 further causes the plurality of uplink transmissions to be performed by the UE 120 with the reduced total transmission power. In this way, the UE 120 may ensure that the total transmission power of overlapped uplink transmissions is lower than the maximum transmission power of the UE 120.

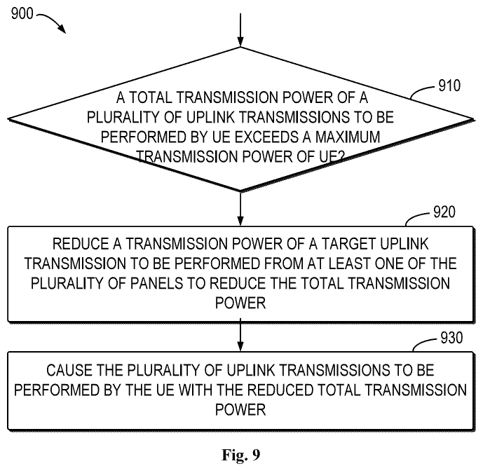

Reference is now made to reference to FIG. 9. FIG. 9 illustrates a flowchart illustrating another example method 900 of power control for multi-panel transmission according to some embodiments of the present disclosure. For the purpose of discussion, the method 900 will be described with reference to FIGS. 1 and 5. The method 900 may involve the UE 120 shown in FIG. 1.

At block 910, the UE 120 determines whether a total transmission power of a plurality of uplink transmissions to be performed by the UE 120 exceeds a maximum transmission power of the UE 120. The plurality of uplink transmissions are overlapped in time. As mentioned above, the plurality of panels 105 may comprise the panel 105-1 and the panel 105-2 as shown in FIG. 1.

The plurality of uplink transmissions overlapped in time may refer to a group of overlapped transmissions which are fully overlapped (e.g., in Case 1) or partially overlapped (e.g., in Case 2). For the purpose of illustration, it is assumed in the following that the uplink transmissions shown in each of FIGS. 5A, 5B and 5C are to be performed from different panels, for example, the panels 150-1 and 150-2. Specifically, the uplink transmissions 505, 510 and 515 are to be performed from the panel 105-1 and the uplink transmissions 520, 525 and 530 are to be performed from the panel 150-2.

If at block 910, the total transmission power of the UE 120 is determined as exceeding the maximum transmission power of the UE 120, the method 900 proceeds to block 920. At block 920, the UE 120 reduces a transmission power of a target uplink transmission to be performed from at least one of the plurality of panels 105 to reduce the total transmission power. In some embodiments, the UE 120 may determine an uplink transmission having the lowest priority among the plurality of transmissions as the target uplink transmission (referred as option 2-1 hereafter). Alternatively, in some embodiments, the UE 120 may determine all the uplink transmissions to be performed by the UE 120 as the target uplink transmissions (referred as option 2-2 hereafter).

In the embodiments where option 2-1 is applied, the UE 120 may determine the target uplink transmission based on a priority order of the plurality of uplink transmissions. The priority of each uplink transmission may be determined based on the characteristics of the transmission.

As an example, the UE 120 may determine the priorities of the uplink transmissions based on channel types of the plurality of uplink transmissions. The types of the plurality of uplink transmissions may comprise PUSCH, PRACH, SRS, PUCCH and the like. Alternatively or in addition, the UE 120 may determine the priorities based on the information carried by the plurality of uplink transmissions. The carried information may comprise SR, HARQ-ACK and CSI. Alternatively or in addition, the UE 120 may determine the priorities based on the traffic types of the plurality of uplink transmissions. For example, the traffic types may comprise URLLC, eMBB and the like. Alternatively or in addition, the UE 120 may determine the priorities based on the periodicities of the plurality of uplink transmissions, or in other words, time domain behaviors of the plurality of uplink transmissions. Example transmissions with the periodicities may comprise an aperiodic transmission, a semi-persistent transmission and a periodic transmission. Alternatively or in addition, the UE 120 may determine the priorities based on the serving cells of the plurality of uplink transmissions. For example, a serving cell may be a PCell or a SCell. Alternatively or in addition, the UE 120 may determine the priorities based on the panel index of each uplink transmission. The panel index may indicate the panel to perform the uplink transmission. The panel index may be defined based on other terminology, e.g., transmitter (Tx) entity index, port group index and so on. The panel index may be determined by the UE 120 or BS 110.

In some embodiments, two or more of the above characteristics of the uplink transmissions may be combined. An example priority order is shown in descending order as follows.
Priority group 1: PRACH transmission on the PCell
Priority group 2: PUCCH transmission with HARQ-ACK information and/or SR or PUSCH transmission with HARQ-ACK information
Priority group 3: PUCCH transmission with CSI or PUSCH transmission with CSI
Priority group 4: PUSCH transmission without HARQ-ACK information or CSI
Priority group 5: SRS transmission, with aperiodic SRS having higher priority than semi-persistent and/or periodic SRS, or PRACH transmission on a serving cell other than the PCell

In some embodiments, the UE 120 may further determine the target uplink transmission based on the panel index. The UE 120 may determine the priorities of the uplink transmissions based on the panel index of each uplink transmission. The UE 120 may determine the priorities based on the panel index if the overlapped uplink transmissions are in the same priority group. For example, for overlapped uplink transmissions in the same priority group, an uplink transmission with a lower panel index may have a higher priority. Alternatively or in addition, the UE 120 may further determine the priority based on the cell group index or serving cell index. The UE 120 may consider the panel index prior to the cell group index and/or serving cell index when determining the priorities. Alternatively, the UE 120 may consider the cell group index and/or serving cell index prior to the panel index when determining the priorities.

Alternatively, in some embodiments, the UE 120 may consider the panel index prior to the above priority groups when determining the priorities. In other words, if the overlapped uplink transmissions are to be performed from different panels, the UE 120 may determine the priorities based on the panel index first. For example, an uplink transmission with a lower panel index may have a higher priority. When the overlapped uplink transmissions are to be performed from a same panel, the UE 120 may determine the priorities based on the priority groups above.

In the embodiments where option 2-2 as mentioned above is applied, the UE 120 may determine all the overlapped uplink transmissions to be performed from the UE 120 as the target uplink transmissions and perform power reduction on all the overlapped uplink transmissions. In this case, the UE 120 may perform power reduction for each panel of the plurality of panels 105. As an example, the UE 120 may reduce a transmission power of a first uplink transmission to be performed from the panel 105-1 based on a first scaling factor and reduce a transmission power of a second uplink transmission to be performed from the panel 105-2 based on a second scaling factor.

In some embodiments, the first scaling factor may be the same as the second scaling factor. In other words, a common scaling factor is used for different panels. In this case, the common scaling factor may be determined based on the total transmission power before power reduction and the maximum transmission power of the UE 120. For example, the common scaling factor may be determined as P_{UE}/Pₜₓ. where P_{UE} represents the maximum transmission power of the UE 120 and Pₜₓ represents the total transmission power before power reduction.

Alternatively, in some embodiments, the first scaling factor may be different from the second scaling factor. In other words, the scaling factor may be determined per panel. In this case, the scaling factor per panel may be determined based on the total number of antenna ports across the plurality of panels 105 and the number of antenna ports per panel. For example, the scaling factor for panel k may be determined as P_{UE}×Nₖ/Nₜₒₜₐₗ. Nₖ represents the number of antenna ports for the panel k. Nₜₒₜₐₗ represents the total number of antenna ports across the plurality of panels 105.

Upon determining the target uplink transmission, the UE 120 may need to determine over which transmission occasion(s) to perform power reduction on the target uplink transmission. In the embodiments where the plurality of uplink transmissions is fully overlapped over the all transmission occasions (as Case 1 described above), the UE 120 may reduce the transmission power for the whole transmission occasion of the target uplink transmission.

In the embodiments where the plurality of uplink transmissions is partially overlapped, the UE 120 may perform the power reduction according to the power reduction option 1, the power reduction option 2 or the power reduction option 3 as described above. If the power reduction option 1 is applied, the UE 120 may perform power reduction on the target uplink transmission only over the overlapped transmission occasion. For example, as shown in FIG. 7A, power reduction is performed on the uplink transmission 510 only over the transmission occasion 501-1. The transmission power over the transmission occasion 501-1 is reduced from Pₜₓ₂ to Pₜₓ₁. As another example, as shown in FIG. 8A, power reduction is perform on the uplink transmission 510 only over the transmission occasions 501-1 and 501-2. The transmission power over the occasions 501-1 and 501-2 is reduced from Pₜₓ₂ to Pₜₓ₁.

If the power reduction option 2 is applied, the UE 120 may perform power reduction on the target uplink transmission over all transmission occasions within a transmission instance if the overlap occurs over a transmission occasion within the transmission instance. For example, as shown in FIG. 7B, power reduction is performed on the uplink transmission 510 over all the transmission occasions 501-1, 501-2 and 501-3. The transmission power over the transmission occasions 501-1, 501-2 and 501-3 is reduced from Pₜₓ₂ to Pₜₓ₁. As another example, as shown in FIG. 8B, the power reduction is performed on the uplink transmission 510 over all transmission occasions 501-1, 501-2 and 501-3 within the transmission instance. The transmission power over the transmission occasions 501-1, 501-2 and 501-3 is reduced from Pₜₓ₂ to Pₜₓ₁.

Referring back to FIG. 9, at block 930, the UE 120 causes the plurality of uplink transmissions to be performed by the UE 120 with the reduced total transmission power. The reduced total transmission power may refer to Pₜₓ₁+Pₜₓ₃ as shown in FIGS. 7A, 7B, 8A and 8B if the uplink transmission 510 is determined as the target uplink transmission with power reduction. Please be noted that, if both the uplink transmission 510 and uplink transmission 525 are determined as the target uplink transmissions, the UE 120 may reduce the transmission power of the uplink transmissions 510 and 525 with a same or different scaling factor. In this case, the reduced total transmission power may be determined differently. In this way, the total transmission power of the UE 120 may be maintained under its maximum transmission power.

In some embodiments, the UE 120 may further determine a PH of the UE 120 and report the PH via a PHR for the UE 120. The PH of the UE 120 may refer to the difference between the maximum transmission power P_{UE} of the UE 120 and a current total transmission power Pₜₓ of the UE 120. For example, if it is assumed that the uplink transmissions 510 and 525 are from the panel 105-1 and the panel 105-2, respectively, the current transmission power of the UE 120 is Pₜₓ₃+Pₜₓ₁. Thus, the PH of the UE 120 may be determined as P_{UE}−Pₜₓ₁−Pₜₓ₃.

In the embodiments where the uplink transmissions are partially overlapped, the power reduction may be performed on the target uplink transmission over at least one transmission occasion. Thus, there may be a transmission occasion with power reduction and a transmission without power reduction in the target uplink transmission. In this case, the UE 120 may determine the PHR of the UE 120 based on the transmission occasions with or without power reduction. In other words, a PHR of the UE 120 may be determined based on specific transmission occasions.

As an example, the PHR of the UE 120 may be determined based on the at least one transmission occasion with power reduction. Alternatively, or in addition, the PHR of the UE 120 may be determined based on a further transmission occasion of the target uplink transmission without power reduction. The UE 120 may transmit to the BS 110 both the PHR with power reduction and the PHR without the power reduction. Alternatively, or in addition, the PHR of the UE 120 may be determined based on a predetermined transmission occasion of the target uplink transmission. The predetermined transmission occasion may be the first or last transmission occasion regardless of whether its power is scaled or not.

To differentiate uplink transmissions from different panels, a correspondence between a panel from which a signal is transmitted and a beam used to transmit the signal may be needed. In some embodiments, the correspondence may be reported by the UE 120 based on PUCCH/PUSCH/or MAC CE.

As an example, the UE 120 may transmit, to the BS 110, a first indication of a beam corresponding to each of the plurality of panels 105 of the UE 120. For example, the beam corresponding to the panel 105-1 is reported to the BS 110. In other words, the UE 120 may report a potential panel for each beam index. The beam index may be represented by a SSB resource indicator (SSBRI), a CSI-RS resource indicator (CRI), a SRS resource set or a SRS resource index. The UE 120 may further receive, from the BS 110, a second indication that the beam corresponding to the panel 105-1 is to be used for the plurality of uplink transmissions. Upon receiving the second indication, the UE 120 may know which beam to be used for each transmission.

In some embodiments, the UE 120 may use an indicated panel for transmitting a signal. The panel for the transmission may be indicated by the BS 110 through a higher layer signaling (such as RRC or MAC CE) or DCI.

As an example, the UE 120 may receive, from the BS 110, a third indication of a beam corresponding to each of the plurality of panels 105 of the UE 120. For example, the beam corresponding to the panel 105-1 is indicated by the BS 110. In other words, the UE 120 may receive a panel index provided for uplink beam indication signaling. The uplink beam indication signaling may be a transmission configuration indicator (TCI) or spatial relation information. The UE 120 may further receive, from the BS 110, a fourth indication that the beam corresponding to the panel 105-1 is to be used for the plurality of uplink transmissions. Upon receiving the fourth indication, the UE 120 may know which beam to be used for a transmission.

It is to be understood that although the power control per panel and power control across panels are described separately, an aspect described with respect to the power control per panel can be applied to power control across panels and vice versa. It is also to be understood that the UE 120 may support both a mode of power control per panel and a mode of power control across panels.

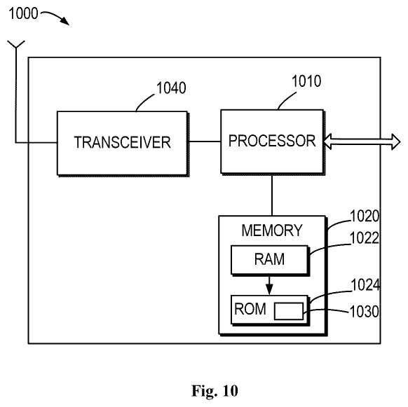

FIG. 10 is a simplified block diagram of a device 1000 that is suitable for implementing embodiments of the present disclosure. For example, the BS 110 and the UE 120 can be implemented by the device 1000. As shown, the device 1000 includes a processor 1010, a memory 1020 coupled to the processor 1010, and a transceiver 1040 coupled to the processor 1010.

The transceiver 1040 is for bidirectional communications. The transceiver 1040 is coupled to at least one antenna to facilitate communication. The transceiver 1040 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program 1030 so that the device 1000 may perform any method of the disclosure as discussed with reference to FIGS. 3, 6 and 9. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out the method 300 as described above with reference to FIG. 3 and/or the method 600 as described above with reference to FIG. 6 and/or the method 900 as described above with reference to FIG. 9.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A user equipment (UE), comprising:
a transceiver configured to communicate with a network; and
a processor communicatively coupled to the transceiver and configured to perform operations comprising:
determining a density of a Phase Tracking-Reference Signal (PT-RS) to be transmitted from a first panel of a plurality of panels of the UE based on a bandwidth scheduled for at least one of the plurality of panels;
mapping the PT-RS to physical resources based on the density; and
transmitting the PT-RS via the transceiver from the first panel to the network by using the mapped physical resources.

2. The UE of claim 1, wherein transform precoding is enabled and determining the density of the PT-RS to be transmitted from the first panel comprises:
determining the number of PT-RS groups within a symbol and the number of PT-RS samples in a PT-RS group based on a threshold and one of:
a bandwidth scheduled for the first panel,
a total bandwidth of bandwidths scheduled for the plurality of panels,
an average bandwidth of bandwidths scheduled for the plurality of panels,
a maximum bandwidth among bandwidths scheduled for the plurality of panels, or
a minimum bandwidth among bandwidths scheduled for the plurality of panels.

3. The UE of claim 2, wherein mapping the PT-RS to the physical resources comprising:
determining an index of each PT-RS sample in the PT-RS groups based on the number of PT-RS groups, the number of PT-RS samples, and the number of subcarriers scheduled for the first panel; and
mapping each PT-RS sample to a subcarrier of the subcarriers scheduled for the first panel by performing a discrete Fourier Transform (DFT) on the PT-RS samples with the indices.

4. The UE of claim 2, wherein transmitting the PT-RS comprises:
generating sequences corresponding to the PT-RS samples in the PT-RS groups based on an identity of the first panel, the identity configured by the network for uplink transmission; and
transmitting the sequences from the first panel to the network by using the mapped physical resources.

5. The UE of claim 2, wherein transmitting the PT-RS comprises:
determining a power scaling factor for the PT-RS based on a modulation and coding scheme (MCS) indicated by the network for at least one of the plurality of panels; and
transmitting the PT-RS from the first panel with a power scaled by the power scaling factor.

6. The UE of claim 1, wherein transform precoding is not enabled and determining the density of the PT-RS to be transmitted from the first panel comprises:
determining a frequency domain density of the PT-RS based on a threshold and one of:
a bandwidth scheduled for the first panel,
a total bandwidth of bandwidths scheduled for the plurality of panels,
an average bandwidth of bandwidths scheduled for the plurality of panels,
a maximum bandwidth among bandwidths scheduled for the plurality of panels, or
a minimum bandwidth among bandwidths scheduled for the plurality of panels; and
determining a time domain density of the PT-RS based on one of:
a modulation and coding scheme (MCS) indicated for the first panel,
a MCS with the highest index among MCSs indicated for the plurality of panels, or
a MCS with the lowest index among the MCSs indicated for the plurality of panels.

7. The UE of claim 6, wherein mapping the PT-RS to the physical resources comprising:
mapping the PT-RS to the physical resources within a first bandwidth scheduled for the first panel based on the frequency domain density and the time domain density, the first bandwidth being non-overlapped with a second bandwidth scheduled for a second panel of the plurality of panels.

8. The UE of claim 7, wherein transmitting the PT-RS comprising:
determining a power scaling factor for the PT-RS based on a demodulation reference signal (DMRS) port scheduled within the first bandwidth; and
transmitting the PT-RS from the first panel with a power scaled by the power scaling factor.

9. The UE of claim 6, wherein mapping the PT-RS to the physical resources comprising:
determining at least one demodulation reference signal (DMRS) port associated with a first PT-RS port used by the first panel based on control information from the network, the first PT-RS port being different from a second PT-RS port used by a second panel of the plurality of panel; and
mapping the PT-RS to the physical resources based on the frequency domain density, the time domain density, a bandwidth scheduled for an uplink transmission corresponding to the at least one DMRS port and a MCS indicated for the uplink transmission.

10. The UE of claim 9, wherein transmitting the PT-RS comprising:
determining a power scaling factor for the PT-RS based on the number of the at least one DMRS port; and
transmitting the PT-RS from the first panel with a power scaled by the power scaling factor.

11. A user equipment (UE), comprising:
a transceiver configured to communicate with a network; and
a processor communicatively coupled to the transceiver and configured to perform operations comprising:
determining whether a total transmission power of a plurality of uplink transmissions to be performed from a first panel of the UE exceeds a maximum transmission power of the first panel, the plurality of uplink transmissions overlapped in time;
in accordance with a determination that the total transmission power exceeds the maximum transmission power, reducing a transmission power of a first uplink transmission of the plurality of uplink transmissions to reduce the total transmission power, the first uplink transmission having a lower priority than a second uplink transmission of the plurality of uplink transmissions; and
causing the plurality of uplink transmissions to be performed from the first panel with the reduced total transmission power.

12. The UE of claim 11, wherein the operations further comprise:
determining a power headroom for each panel of a plurality of panels of the UE, the plurality of panels comprising the first panel; and
transmitting, via the transceiver, at least one of power headrooms determined for the plurality of panels to the network.

13. The UE of claim 11, wherein the operations further comprise:
determining a power headroom for each panel of a plurality of panels of the UE, the plurality of panels comprising the first panel;
determining power information concerning the plurality of panels based on at least one of:
a sum of power headrooms determined for the plurality of panels,
an average of the power headrooms determined for the plurality of panels,
a minimum power headroom among the power headrooms determined for the plurality of panels, or
a maximum power headroom among the power headrooms determined for the plurality of panels; and
transmitting, via the transceiver, the power information to the network.

14. The UE of claim 11, wherein reducing the transmission power comprises:
reducing the transmission power within at least one transmission occasion of the first uplink transmission, the plurality of uplink transmissions at least partially overlapped over the at least one transmission occasion.

15. The UE of claim 14, wherein the operations further comprises:
determining a power headroom of the first panel based on at least one of:
the at least one transmission occasion of the first uplink transmission,
a further transmission occasion of the first uplink transmission without reduction of transmission power, or
a predetermined transmission occasion of the first uplink transmission.

16. The UE of claim 11, wherein reducing the transmission power comprises:
reducing the transmission power for all transmission occasions of the first uplink transmission.

17. The UE of claim 16, wherein channel estimation on the first uplink transmission is performed by the network across different slots.

18. The UE of claim 11, wherein the operations further comprises:
transmitting, via the transceiver to the network, a first indication of a beam corresponding to each of a plurality of panels of the UE, the plurality of panels comprising the first panel; and
receiving, via the transceiver from the network, a second indication that the beam corresponding to the first panel is to be used for the plurality of uplink transmissions.

19. The UE of claim 11, wherein the operations further comprises:
receiving, via the transceiver from the network, a third indication of a beam corresponding to each of a plurality of panels of the UE, the plurality of panels comprising the first panel; and
receiving, via the transceiver from the network, a fourth indication that the beam corresponding to the first panel is to be used for the plurality of uplink transmissions.

20. The UE of claim 11, wherein priorities of the plurality of uplink transmissions are determined based on at least one of:
channel types of the plurality of uplink transmissions,
information carried by the plurality of uplink transmissions,
traffic types of the plurality of uplink transmissions,
periodicities of the plurality of uplink transmissions, or
serving cells of the plurality of uplink transmissions.

21-32. (canceled)
